(19) United States
(12) Patent Application Publication
(10) Pub. No.: US 2021/0300403 A1
(43) Pub. Date: Sep. 30, 2021

(54) VEHICLE CONTROLLER AND VEHICLE CONTROL METHOD

(71) Applicant: TOYOTA JIDOSHA KABUSHIKI KAISHA, Toyota-shi (JP)

(72) Inventors: Takahiko KUWABARA, Yokohama-shi (JP); Kiyotoshi SEKINE, Katsushika-ku (JP); Shunichiroh SAWAI, Edogawa-ku (JP)

(21) Appl. No.: 17/215,174

(22) Filed: Mar. 29, 2021

(30) Foreign Application Priority Data
Mar. 31, 2020 (JP) 2020-064550

(51) Int. Cl. B60W 50/16; B60W 60/00; B60W 50/08

(52) U.S. Cl. CPC B60W 50/16; B60W 60/0057; B60W 2050/143; B60W 50/082; B60W 60/0053

(57) ABSTRACT

The vehicle controller is configured to have a transition request notification unit which, when a first condition is satisfied, notifies a driver, by a first aspect, of a request of a driving transition from an autonomous driving mode in which operation by the driver during traveling is not necessary to a manual driving mode in which operation by the driver during traveling is necessary, and when a second condition, which has an urgency lower than the first condition, is satisfied, notifies the driver, by a second aspect having a lower strength than the first aspect, of the request of the driving transition, and when the driving transition has not been performed after a second aspect notification period has elapsed from the notification by the second aspect, notifies the request of the driving transition by the first aspect.

### CROSS-REFERENCE TO RELATED APPLICATION

This application claims priority to Japanese Patent Application No. 2020-64550 filed on Mar. 31, 2020, and is incorporated herein by reference in its entirety.

### FIELD

The present disclosure relates to a vehicle controller and a vehicle control method for notifying a driver of a request of a driving transition from autonomous driving to manual driving.

### BACKGROUND

Technologies in which a vehicle controller controls vehicle driving using an image showing the surrounding situation of the vehicle captured by a camera mounted on the vehicle are known. When control of the driving of the vehicle by the vehicle controller (hereinafter referred to as “autonomous driving”) starts, it is not necessary for the driver to perform various driving operations.

When a driving transition request situation determined based on the surrounding situation of the vehicle, the state of the driver, etc., is satisfied, the vehicle controller executes a driving transition request which alerts the driver to end autonomous driving and start manual driving. The driver, who has been alerted by the driving transition request, can start manual driving with ease.

Japanese Unexamined Patent Publication (Kokai) No. 2017-123054 (hereinafter referred to as Patent Literature 1) describes an alarm device which enables a driver to prepare for starting manual operation safely and with ease. The alarm device described in Patent Literature 1 outputs an alarm at a timing determined based on a comparison result between the remaining time until the end of autonomous driving and the preparation time necessary for the driver to start manual driving.

### SUMMARY

Driving transition requests are carried out by an aspect which enables the driver to recognize that a driving transition is being requested. It can be assumed that there are various situations as the cause of the request for driving transition. Depending on the situation, the driver can recognize with time to spare that a driving transition is requested. In such situations, the driver may find the driving transition request by an aspect which can be reliably recognized by the driver annoying.

The present disclosure aims to provide a vehicle controller which can notify the driver of the driving transition request by aspects depending on the situation in which the driving transition is requested.

A vehicle controller according to the present disclosure comprises a transition request notification unit which, when a first condition is satisfied, notifies a driver, by a first aspect, of a request of a driving transition from an autonomous driving mode in which operation by the driver during traveling is not necessary to a manual driving mode in which operation by the driver during traveling is necessary, and when a second condition, which has an urgency lower than the first condition, is satisfied, notifies the driver, by a second aspect having a lower strength than the first aspect, of the request of the driving transition, and when the driving transition has not been performed after a second aspect notification period has elapsed from the notification by the second aspect, notifies the request of the driving transition by the first aspect.

In the vehicle controller according to the present disclosure, the transition request notification unit preferably ends notification by the second aspect when the driving transition has been performed before the second aspect notification period elapses from notification by the second aspect.

In the vehicle controller according to the present disclosure, the transition request notification unit preferably ends notification by the first aspect when the driving transition has been performed after notification by the first aspect.

In the vehicle controller according to the present disclosure, the first aspect is preferably an aspect which attracts attention of the driver more strongly than the second aspect.

The vehicle controller according to the present disclosure preferably further comprises a driving transition control unit which, when notification by the first aspect or notification by the second aspect has been performed, executes the driving transition from the autonomous driving mode to the manual driving mode when driving operations by the driver are detected.

A vehicle control method according to the present disclosure comprises the steps of, when a first condition is satisfied, notifying a driver, by a first aspect, of a request of a driving transition from an autonomous driving mode in which operation by the driver during traveling is not necessary to a manual driving mode in which operation by the driver during traveling is necessary, and when a second condition, which has an urgency lower than the first condition, is satisfied, notifying the driver, by a second aspect having a lower strength than the first aspect, of the request of the driving transition, and when the driving transition has not been performed after a second aspect notification period has elapsed from the notification by the second aspect, notifying the request of the driving transition by the first aspect.

According to the vehicle controller of the present disclosure, the driver can be notified of the driving transition request by aspects depending on the situation in which the driving transition is requested.

### BRIEF DESCRIPTION OF DRAWINGS

Other features and advantages of the present disclosure will be apparent from the ensuing description, taken in conjunction with the accompanying drawings, in which:

FIG. 1 is a schematic configuration view of a vehicle in which the vehicle controller is implemented;

FIG. 2A is a view detailing a first example of driving transition notification;

FIG. 2B is a view detailing a second example of driving transition notification;

FIG. 3 is a schematic hardware diagram of an ECU;

FIG. 4 is a functional block diagram of a processor included in the ECU;

FIG. 5 is a flowchart of driving transition request processing.

### DESCRIPTION OF EMBODIMENTS

A vehicle controller which can notify a driver of a driving transition request by aspects depending on the situation in which the driving transition is requested will be described in detail below referring to the drawings. However, it should be understood that the present disclosure is not limited to embodiments illustrated in the drawings or described below.

When a first condition is satisfied, the vehicle controller notifies the driver, by a first aspect, of a request of a driving transition from an autonomous driving mode to a manual driving mode. When a second condition, which has a lower urgency than the first condition, is satisfied, the vehicle controller notifies the driver of the request of the driving transition by a second aspect, which has a lower strength than the first aspect. When the driving transition has not been performed after a second aspect notification period has elapsed from the notification by the second aspect, the vehicle controller notifies the request of the driving transition by the first aspect. As a result, the vehicle controller can notify the driver of the request of the driving transition by aspects depending on the situation in which the driving transition is requested.

The embodiments of the vehicle controller which notifies the driver of a request of a driving transition from autonomous driving to manual driving will be described below.

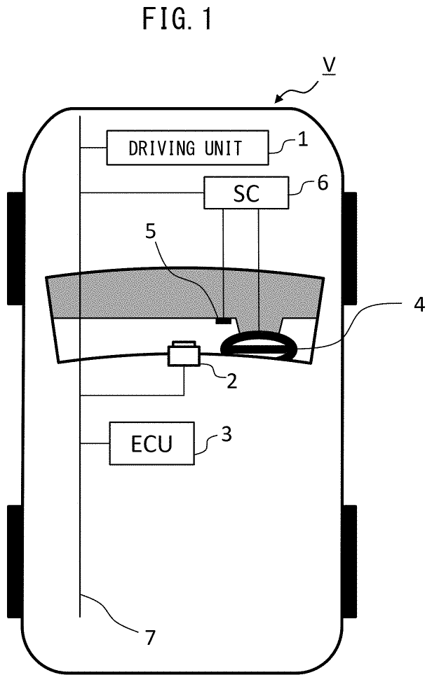

FIG. 1 is a schematic configuration view of the vehicle in which the vehicle controller is implemented.

A vehicle V comprises a driving unit 1, a camera 2, an ECU (electronic control unit) 3, a steering wheel 4, an autonomous driving end switch 5, an SC (steering controller) 6, and an in-vehicle network 7.

The driving unit 1 increases and decreases the driving speed of the vehicle V and steers the vehicle V. The driving unit 1 includes, for example, an engine which supplies power to the vehicle V, a brake which reduces the driving speed of the vehicle V, and a steering mechanism which steers the vehicle V.

The camera 2 is an example of a sensor for detecting the situation around the vehicle. The camera 2 is arranged in the upper front part of the vehicle interior so as to face forward, captures the situation around the vehicle through the windshield, and outputs an image corresponding to the surrounding situation.

The ECU 3 is an example of a vehicle controller and is an electronic controller which executes calculation based on input signals and outputs calculation results. The configuration of the ECU 3 is described later.

The steering wheel 4 is an example of a driving operation reception unit and receives operations by the driver requesting actuation of the steering mechanism. The operations requesting actuation of the steering mechanism include, for example, an operation in which the steering wheel 4 is rotated clockwise or counterclockwise. The vehicle V comprises an accelerator pedal and a brake pedal (not illustrated) as other operation reception units.

The autonomous driving end switch 5 is, for example, a switch provided in the vicinity of the steering wheel 4. The autonomous driving end switch 5 receives the operation of the driver desiring to end the autonomous driving mode and to start manual driving, and generates an operation signal corresponding to the operation.

The SC 6 generates signals corresponding to the states of the steering wheel 4 and the autonomous driving end switch 5 and outputs them to the ECU 3.

The driving unit 1, camera 2, ECU 3, and SC 6 are communicably connected via the in-vehicle network 7. The in-vehicle network 7 is a communication network in compliance with, for example, CAN (controller area network).

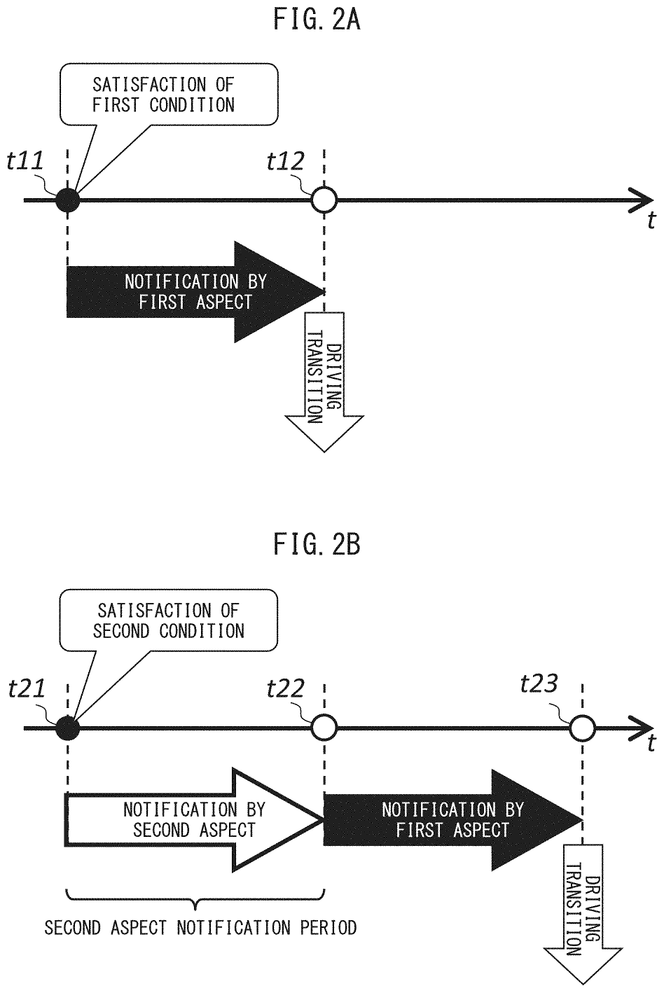

FIG. 2A-2B illustrates views detailing examples of driving transition notification.

In the first example shown in FIG. 2A, when the first condition is satisfied at time t11, the vehicle controller notifies the driver of the driving transition request by the first aspect. When the driving transition is performed at time t12, notification by the first aspect ends.

In the second example shown in FIG. 2B, when the second condition is satisfied at time t21, the vehicle controller notifies the driver of the driving transition request by the second aspect. Next, at time t22, after the second aspect notification period has elapsed from the time t21 at which notification by the second aspect started, driver is notified of the driving transition request by the first aspect. When the driving transition is performed at time t23, notification by the first aspect ends.

The second condition has a lower urgency than the first condition. For example, environmental factors such as malfunction of autonomous driving system of the vehicle V and detection of construction on the road on which vehicle V is traveling are set as the first condition. At this time, operation of the autonomous driving end switch by the driver, the position of vehicle V reaching the end of the map used for autonomous driving, etc., are set as the second condition, which has a lower urgency than the first condition.

The second aspect is an aspect having a lower strength than the first aspect. For example, the display of a color having a low color temperature (red, yellow, etc.), intermittent beeping, a loud sound, or the activation of a tactile alarm by a seatbelt, etc., is used as the first aspect. At this time, the display of a color having a high color temperature (blue, white, etc.), a single beep, a quiet sound, etc., is used as the second aspect, which is an aspect having a lower strength than the first aspect. The first aspect is an aspect which attracts the attention of the driver more strongly than the second aspect.

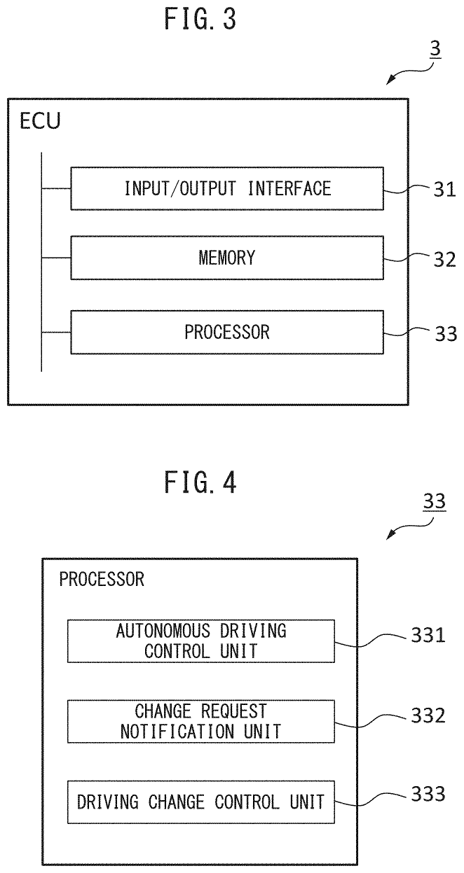

FIG. 3 is a schematic hardware diagram of the ECU 3.

The ECU 3 autonomously drives the vehicle V in the autonomous driving mode by controlling the driving unit 1 based on the image output by the camera 2. Furthermore, the ECU 3 determines whether or not the first condition or the second condition has been satisfied based on signals output by equipment mounted on the vehicle V. Further, the ECU 3 notifies the driver of the driving transition request when the first condition or the second condition is satisfied. To this end, the ECU 3 comprises an input/output interface 31, a memory 32, and a processor 33.

The input/output interface 31 is an example of a communication unit and has an interface circuit for performing the input/output of data between the ECU 3 and other devices. The input/output interface 31 provides received data to the processor 33. Furthermore, the input/output interface 31 outputs data provided from the processor 33 to the outside. The input/output interface 31 is a circuit for performing communication in compliance with, for example, CAN.

The memory 32 is an example of a storage unit and includes a volatile semiconductor memory and a non-volatile semiconductor memory. The memory 32 stores various data used in the processing by the processor 33, for example, the first condition, the second condition, and the second aspect notification period, as well as various application programs such as an autonomous driving control program which executes autonomous driving control, etc.

The processor 33 is an example of a control unit and has one or more processors and peripheral circuits therefor. The processor 33 may further comprise another calculation circuit such as a logical operation unit, an arithmetic operation unit or a graphics processing unit.

FIG. 4 is a functional block diagram of the processor 33 included in the ECU 3.

The processor 33 of the ECU 3 comprises, as functional blocks, an autonomous driving control unit 331, a transition request notification unit 332, and a driving transition control unit 333. Each of these units included in the processor 33 is a functional module executed by a program executed by the processor 33. Alternatively, each of these units included in the processor 33 may be executed by the ECU 3 as an independent integrated circuit, microprocessor, or firmware.

The autonomous driving control unit 331 receives the image output by the camera 2, which is connected to the in-vehicle network 7, via the input/output interface 31. The autonomous driving control unit 331 identifies features around the vehicle V by inputting the received image into a pre-trained classifier to detect features shown in the image. The features are objects or indications present around the road, and include, for example, lane marking lines displayed for dividing the lanes of a road and traveling vehicles other than the vehicle V.

The classifier can be, for example, a convolutional neural network (CNN) having a plurality of layers connected in series from the input side to the output side. By inputting the image including the features to be detected into the CNN in advance as training data and performing training, the CNN operates as the classifier for detecting images including the features to be detected.

The autonomous driving control unit 331 outputs control signals to the driving unit 1, via the in-vehicle network 7, based on the features identified from the received image, to ensure that the vehicle V properly remains in the lane on route to the destination. For example, the autonomous driving control unit 331 outputs control signals to the driving unit 1 to keep the distance from the lane markings constant. Furthermore, the autonomous driving control unit 331 outputs control signals to the driving unit 1 to keep the distance from other vehicles driving ahead constant.

The transition request notification unit 332 determines whether or not the first condition is satisfied, during driving by control of the autonomous driving control unit 331, based on the signals, etc., received via the input/output interface 31. When it is determined that the first condition has been satisfied, the transition request notification unit 332 notifies the driving transition request to the driver by the first aspect.

The first condition is the reception of a signal output by the autonomous driving control unit 331 when autonomous driving becomes impossible, or the detection of a feature indicating road construction from an image captured by the camera 2. The first condition corresponds to an event with a relatively high urgency. The first condition is stored in the memory 32 in advance. The first condition may be the reception of a signal corresponding to an event having a high urgency other than those above. Further, the first condition may be a combination of a plurality of these.

Notification by the first aspect is performed by the display of a color having a low color temperature on the instrument panel or a heads-up display (not illustrated) provided in the passenger compartment, intermittent beeping or a loud sound from an unillustrated speaker, or vibration of unillustrated seatbelts. The first aspect is an aspect having a relatively high strength. The first aspect is stored in advance in the memory 32. Note that the first aspect may be an aspect having a high strength other than those above. Furthermore, the first aspect may be a combination of a plurality of these.

Furthermore, during driving by control of the autonomous driving control unit 331, the transition request notification unit 332 determines whether or not the second condition has been satisfied based on signals, etc., received via the input/output interface 31. When it is determined that the second condition has been satisfied, the transition request notification unit 332 notifies the driver of the driving transition request by the second aspect. When the driving transition has not been performed after the second aspect notification period has elapsed from the notification by the second aspect, the driving transition request is notified by the first aspect.

The second condition is the reception of a signal output by the SC 6 when the autonomous driving end switch 5 is operated by the driver, or the detection that the position of the vehicle V has reached the end of the map used for autonomous driving control by the autonomous driving control unit 331 stored in the memory 32. The second condition corresponds to an event with a relatively low urgency. The second condition is stored in the memory 32 in advance. The second condition may be the reception of a signal corresponding to an event having a low urgency other than those above. Furthermore, the second condition may be a combination of a plurality of these.

Notification by the second aspect is performed by displaying a color having a high color temperature on the instrument panel or a heads-up display (not illustrated) provided in the passenger compartment, or a single beep or a quiet sound from an unillustrated speaker. The second aspect is an aspect having a relatively low strength. The second aspect is stored in the memory 32 in advance. The second aspect may be an aspect having a low strength other than those above. Furthermore, the second aspect may be a combination of a plurality of these.

The second aspect notification period is a period (for example, 4 seconds) during which the driver, recognizing the driving transition request, should prepare before the start of manual driving, and is stored in the memory 32 in advance.

The driving transition control unit 333 executes the driving transition from the autonomous driving mode to the manual driving mode when driving operations by the driver are detected during the time in which the driving transition request by the first aspect or the driving transition request by the second aspect is performed. Specifically, the driving transition control unit 333 ends control of the driving unit 1 by the autonomous driving control unit 331. In the manual driving mode, the driving unit 1 is operated based on the driver operations received by the steering wheel 4, etc.

When the driving transition control unit 333 executes the driving transition, the notification of the driving transition by the transition request notification unit 332 ends. Specifically, when the driving transition control unit 333 executes the driving transition, a replacement flag is written in a predetermined area of the memory 32. The transition request notification unit 332 regularly accesses the predetermined area of the memory 32 and ends the driving transition request when the replacement flag is detected.

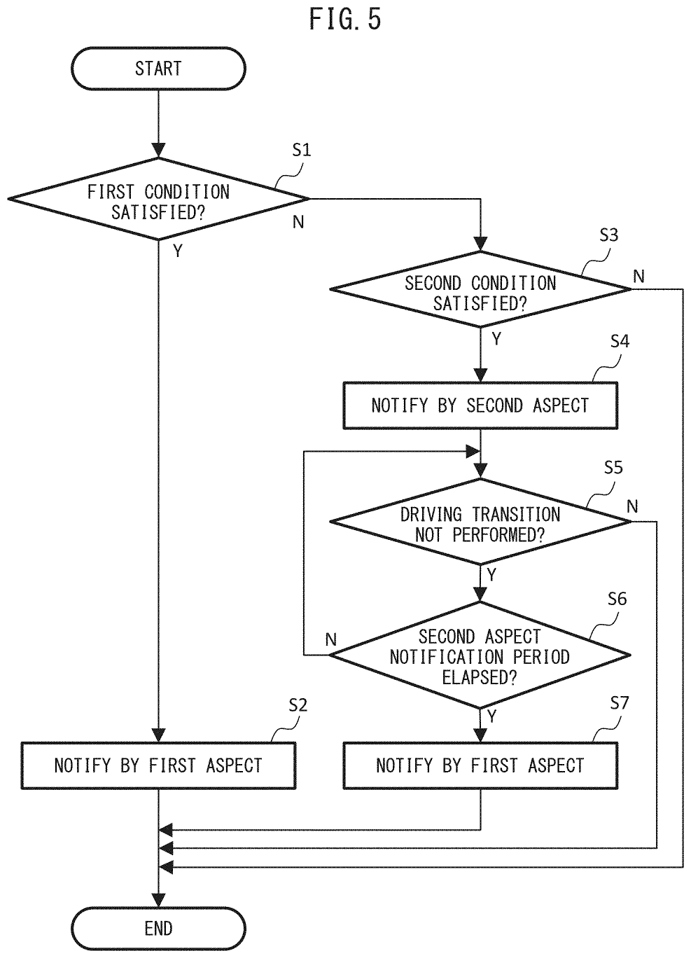

FIG. 5 is a flowchart of driving transition request processing. The ECU 3 repeatedly executes the driving transition request at predetermined cycles during driving of the vehicle V in the autonomous driving mode.

First, the transition request notification unit 332 detects whether or not the first condition has been satisfied (step S1). When it is detected that the first condition has been satisfied (step S1: Y), the transition request notification unit 332 notifies the driving transition request by the first aspect (step S2), and the processor 33 ends the driving transition request processing.

When it is determined that the first condition has not been satisfied (step S1: N), the transition request notification unit 332 determines whether or not the second condition has been satisfied (step S3). When it is determined that the second condition has not been satisfied (step S3: N), the processor 33 ends the driving transition request processing.

When it is determined that the second condition has been satisfied (step S3: Y), the transition request notification unit 332 notifies the driver of the driving transition request by the second aspect (step S4).

Next, the transition request notification unit 332 determines whether or not the driving transition has not yet been performed (step S5), and when it is determined that the driving transition has been performed (step S5: N), the processor 33 ends the driving transition request processing.

When it is determined that the driving transition has not been performed (step S5: Y), the transition request notification unit 332 determines whether the second aspect notification period has elapsed from the notification by the second aspect (step S6).

When it is determined that the second aspect notification period has not elapsed from the notification by the second aspect (step S6: N), the processing by the transition request notification unit 332 returns to step S5.

When it is determined that the second aspect notification period has elapsed from the notification by the second aspect (step S6: Y), the transition request notification unit 332 notifies the driving transition request by the first aspect (step S7), and the processor 33 ends the driving transition request processing.

Note that the notification by the first aspect in step S2 or step S7 is continuously performed until it is determined that the driving transition has been performed. When it is not determined that the driving transition has been performed within a predetermined period of time from the notification by the first aspect, the processor 33 may execute a process (for example, control to stop the vehicle V on the shoulder, etc.) specified to be executed when the driver is determined to be in an abnormal state.

Furthermore, the notification by the second aspect in step S4 is continuously performed until it is determined that the driving transition has been performed (step S5: N) or until the second aspect notification period has elapsed from the notification by the second aspect (step S6: Y).

As a result of the ECU 3 executing the driving transition request processing as described above, the ECU 3 can notify the driver of the driving transition request by aspects depending on the situation in which the driving transition is requested.

According to a modified example, the camera 2 may be a LIDAR (light detection and ranging) sensor which captures a distance image of the surroundings of the vehicle V. The distance image is an image in which each pixel has a value corresponding to the distance to the object represented by the pixel.

A person skilled in the art could understand that various changes, replacements, and modification can be made without deviating from the spirit and scope of the present disclosure.

What is claimed is:

1. A vehicle controller, comprising a processor configured to:
when a first condition is satisfied, notify a driver, by a first aspect, of a request of a driving transition from an autonomous driving mode in which operation by the driver during traveling is not necessary to a manual driving mode in which operation by the driver during traveling is necessary, and
when a second condition, which has an urgency lower than the first condition, is satisfied, notify the driver, by a second aspect having a lower strength than the first aspect, of the request of the driving transition, and when the driving transition has not been performed after a second aspect notification period has elapsed from the notification by the second aspect, notify the request of the driving transition by the first aspect.

2. The vehicle controller according to claim 1, wherein the processor is further configured to end notification by the second aspect when the driving transition has been performed before the second aspect notification period elapses from notification by the second aspect.

3. The vehicle controller according to claim 1, wherein the processor is further configured to end notification by the first aspect when the driving transition has been performed after notification by the first aspect.

4. The vehicle controller according to claim 1, wherein the first aspect is an aspect which attracts attention of the driver more strongly than the second aspect.

5. The vehicle controller according to claim 1, wherein the processor is further configured to, when notification by the first aspect or notification by the second aspect has been performed, execute the driving transition from the autonomous driving mode to the manual driving mode when driving operations by the driver are detected.

6. A vehicle control method, comprising:
when a first condition is satisfied, notifying a driver, by a first aspect, of a request of a driving transition from an autonomous driving mode in which operation by the driver during traveling is not necessary to a manual driving mode in which operation by the driver during traveling is necessary, and
when a second condition, which has an urgency lower than the first condition, is satisfied, notifying the driver, by a second aspect having a lower strength than the first aspect, of the request of the driving transition, and when the driving transition has not been performed after a second aspect notification period has elapsed from the notification by the second aspect, notifying the request of the driving transition by the first aspect.
